(19) United States
(12) Patent Application Publication
(10) Pub. No.: US 2008/0015097 A1
(43) Pub. Date: Jan. 17, 2008

(54) Assembly Cell For Assembling Modules From Work Pieces On Pallets, As Well As Method For Its Operation

(76) Inventor: Helmut Jaeger, Koenigsbach-Stein (DE)

Correspondence Address: Walter A. Hackler;Patent Law Office, 2372 S.E. Bristol Street, Suite B, Newport Beach, CA, 92660-0755, US

(21) Appl. No.: 11/792,789

(22) PCT Filed: Aug. 31, 2005
(86) PCT No.: PCT/DE05/01520

§ 371 Date: Jun. 11, 2007

(30) Foreign Application Priority Data
Dec. 14, 2004 (DE) 10 2004 062 377.5

(51) Int. Cl. B23Q 7/14; B23P 21/00

(52) U.S. Cl. 483/15

(57) ABSTRACT

The invention pertains to an assembly cell (1; 21, 22) that is suitable for the assembly of modules (55) from work pieces (35) on pallets (33; 42, 43; 54; 68, 69) and features several pallet stations (3a, 3b, 3c, 3d, 3e, 3f, 3g, 3h), in which pallets can be positioned, wherein at least some of the pallet stations are realized in the form of assembly stations for carrying out assembly work on the modules on the pallets., and with at least one transport device for transporting the pallets between the pallet stations. The invention is characterized in that the transport device is realized in the form of a triaxial module (2; 23, 24) that is able to transport an individual pallet from any pallet station within the assembly cell to any other unoccupied pallet station within the assembly cell. The invention therefore makes available an assembly cell, by means of which modules can be assembled independently of the spatial arrangement of the assembly stations, wherein said assembly cell requires fewer pallets and makes it possible to realize a faster transport of the pallets from assembly station to assembly station.

The invention pertains to an assembly cell that is suitable for assembling modules from work pieces on pallets and comprises several pallet stations, at which pallets can be positioned, wherein at least some of the pallet stations are realized in the form of assembly stations for carrying out assembly work on the modules on the pallets, and comprising at least one transport device for transporting the pallets between the pallet stations.

For example, such an assembly cell, i.e., assembly line, is known from DE 195 04 457 A1.

In order to assemble modules from work pieces such as, for example, transmissions from shafts, bearings, gears, ring seals, etc., the work pieces are delivered to the module in a certain sequence and assembled. In this case, manual assembly work (carried out by workers) typically alternates with automated assembly work (carried out by machines).

In the state of the art, assembly lines are used for the assembly of modules. Such an assembly line comprises a conveyor belt, e.g., a friction-type roller conveyor or a belt container, on which pallets are transported. The modules are situated on the pallets. Assembly stations are arranged along the conveyor belt. The conveyor belt has a fixed conveying direction such that the pallets pass through the assembly stations in a specific sequence. The conveyor belt sections between the individual assembly stations serve as local buffers. However, these local buffers only have a small capacity due to the required floor space.

In these assembly lines, most assembly stations experience long idle times, in which no assembly work is carried out. Only the assembly station with the longest assembly cycle is operating at full capacity. This results in a “bottleneck” in the assembly line. The assembly lines are also relatively inflexible. The design of an assembly line is defined by the spatial sequence of the assembly stations that serves for realizing a certain assembly sequence of a single module. If the module is changed, it is necessary to modify the assembly line or even to regroup the assembly stations.

A modular assembly line system is known from DE 195 04 457 A1. In this case, pallets are transported on a circulating conveyor belt that has a fixed conveying direction. Assembly stations are arranged around the conveyor belt, wherein each assembly station features its own feed-in and feed-out section for delivering an individual pallet from the circulating conveyor belt to the respective assembly station and vice versa. In the modular assembly line system, the spatial sequence of the assembly stations can be chosen independently of the work sequence to be performed on the modules on the pallets.

However, one disadvantage of the described modular assembly line system is that the transport of a pallet from assembly station to assembly station by means of the circulating conveyor belt is very time-consuming. Another disadvantage is the large number of pallets that circulates on the conveyor belt and is required for the operation of this assembly line system.

### OBJECTIVE OF THE INVENTION

Consequently, the invention is based on the objective of making available an assembly cell, in which modules can be assembled independently of the spatial arrangement of the assembly stations, wherein this assembly cell also requires fewer pallets and the transport of the pallets from assembly station to assembly station can be realized more rapidly.

### DESCRIPTION OF THE INVENTION

In an assembly cell of the initially cited type, this objective is attained, according to the invention, in that the transport device is realized in the form of a triaxial module that is able to directly transport an individual pallet from any pallet station within the assembly cell to any other unoccupied pallet station within the assembly cell.

The inventive assembly cell comprises a plurality of pallet stations. Pallet stations are locations within the assembly cell, at which pallets are positioned during the normal operation of the assembly cell, namely not only during the transport of a pallet. Pallet stations are realized, for example, in the form of manual assembly stations, automated assembly stations, semi-automated assembly stations, buffer areas, etc. The term pallet refers to any type of carrier for work pieces or modules, in particular wherein movable parts are provided that serve as assembly aids for the work pieces or modules to be assembled. The pallets are able to change their pallet station with the aid of the triaxial module. For this purpose, the triaxial module travels to the initial pallet station of a pallet, picks up the pallet, travels to the destination pallet station and deposits the pallet.

In contrast to the circuiting conveyor belt used in the state of the art, the triaxial module is able to directly transport a pallet from any pallet station to any other pallet station. According to the invention, the transport takes place directly if the transport device, i.e., the triaxial module, increasingly shortens the spatial distance to the destination during the transport. The transport would not take place directly in the sense of the invention if the pallet would intermediately arrive at another pallet station (such as an assembly station) during the transport from the initial pallet station to the destination pallet station.

The transport by means of the triaxial module therefore takes place particularly fast. In order to achieve a particularly high transport speed, the triaxial module may be equipped with a linear motor, particularly for displacing the triaxial module back and forward along a principal conveying direction. According to the invention, transport times of 1 second and less can be achieved between two pallet stations (such as assembly stations), wherein the assembly times at manual assembly stations typically amount to 20-60 seconds and the assembly times at automated assembly stations typically amount to 5-10 seconds. Due to this type of transport, only one pallet that is currently situated in the triaxial module is tied up in the inventive assembly cell.

On the other hand, the triaxial module makes it possible to control the acceleration of the pallets during the transport particularly well; the acceleration is not defined by frictional processes on a conveyor belt. This prevents impulses from acting upon the pallets and their modules and a tilting risk is eliminated.

The pallet stations, particularly the assembly stations, are typically arranged in a row parallel to a principal conveying direction of the transport module. The principal conveying direction typically extends horizontally and straight (X-direction), but may also be realized in an ascending, descending and/or arc-shaped fashion or feature arc-shaped sections. The triaxial module can also be displaced in two other directions, typically in the vertical direction (Z-direction) and in the horizontal direction transverse to the principal conveying direction (Y-direction). The displacement in the Y-direction makes it possible to access pallet stations that are arranged in a row parallel to the principal conveying direction. The movement of the triaxial module in any of the axial directions (X, Y, Z) may take place, in principle, independently of the position or the movement of the other axial directions. The triaxial module advantageously features a NC or CNC control (CNC: computerized numerical control; NC: numerical control).

The triaxial module makes it possible for a pallet to access the pallet stations and, in particular, the assembly stations in arbitrary sequence. The assembly cell therefore can be used for any sequence of assembly stations in the assembly of a module on a pallet without requiring modifications. The assembly sequence of a pallet can be established and controlled by means of software only.

In this case, it is possible, in particular, to handle different types of pallets that respectively carry different modules and therefore have different assembly sequences with the same assembly cell, namely either successively or simultaneously and without requiring modifications.

In addition, the inventive assembly cell makes it possible to easily access the same assembly station several times in the assembly sequence of a module on a pallet and to respectively carry out different assembly sequences at this assembly station. Consequently, the capacity utilization of this assembly station can be increased. This is advantageous for assembly stations, in which the assembly cycles are short in comparison with the remaining assembly stations, particularly automated assembly stations such as joining devices or presses. It is advantageous to arrange pallet stations (particularly assembly stations and buffer areas) that are accessed several times during an assembly sequence at a central location of the assembly cell in order to ensure the shortest and fastest access possible.

In the context of the invention, a computer control advantageously defines the sequence of transport processes of the triaxial module in the assembly cell. Known priority-controlled algorithms may be used for this purpose. The software of the computer control may utilize, in particular, the concept of “agent-oriented intelligence.” The priorities of the algorithms may consist, for example, of a high capacity utilization of certain assembly stations or a high throughput of certain types of pallets. The assembly progress in individual assembly cells can be monitored in a fully automated fashion.

According to one particularly preferred embodiment of the inventive assembly cell, at least some of the pallet stations are realized in the form of buffer areas, at which no assembly work can be carried out on the modules. The capacity utilization of the assembly stations can be increased by providing such buffer areas, wherein the definition of the transport sequence of the triaxial module also becomes less complex. If a failure occurs in individual assembly stations, these buffer areas furthermore make it possible to continue the assembly in the remaining assembly stations for a certain period of time. Buffer areas provided in an assembly cell may be utilized, in principle, by all assembly stations.

In one preferred additional development of this embodiment, several buffer areas are arranged vertically on top of one another, wherein it is particularly preferred that at least three buffer areas are arranged vertically on top of one another. The overall design of the assembly cell becomes more compact due to this vertical arrangement. In many applications it suffices to arrange two buffer areas vertically on top of one another.

In one particularly preferred embodiment of the inventive assembly cell, the assembly cell comprises at least one manual assembly station, for carrying out assembly work by a worker, wherein the manual assembly station is realized in a height-adjustable fashion. The vertical adjustability makes it possible to adapt the manual assembly station to the body size of the worker. This prevents ailments of the worker and improves the occupational safety. It generally suffices to design the supporting surface for the pallet in a height-adjustable fashion. The triaxial module (in contrast to the conveyor belt systems according to the state of the art) can also be vertically adjusted such that it is easily possible to deposit a pallet at an arbitrary height.

In one particularly preferred embodiment, the assembly cell features at least one manual double assembly station, wherein each manual double assembly station comprises two manual assembly stations, at which a worker can alternately carry out assembly work. While the worker carries out assembly work at the first manual assembly station, an already processed pallet may be replaced by a pallet yet to be processed in the second manual assembly station. As soon as the worker is finished with the pallet in the first manual assembly station, assembly work can immediately continue in the second manual assembly station, etc. This eliminates an idle time in the form of a pallet changing time. The capacity of the worker can be better utilized in this fashion. According to the invention, identical assembly work sequences, different assembly work sequences or alternating assembly work sequences may be carried out in both manual assembly stations.

In another particularly advantageous embodiment of an inventive assembly cell, the assembly cell features at least one manual assembly station with a displaceable protective shield, particularly a safety roller shutter, that can be displaced between two positions, wherein access to the pallet station of the manual assembly station is completely blocked for a worker in the first position of the protective shield while the transport device is able to access the pallet station of the manual assembly station in this first position, and wherein a worker is able to access the pallet station of the manual assembly station in order to carry out assembly work in the second position of the protective shield while access to the pallet station of the manual assembly station is completely blocked for the transport device in this second position. The protective shield is sufficiently robust such that it cannot be shattered by the transport device in case of a controlling error. The protective shield ensures the utmost degree of occupational safety for a worker who is active in the manual assembly station. Since the protective shield separates the worker from the transport device in its first and its second position, it is impossible for the worker to reach into the movable parts of the transport device. It is furthermore preferred that at least one access is completely blocked in any position of the protective shield between the first and the second position. This can be easily realized, for example, with a safety roller shutter that sufficiently protrudes over the openings of the access points to the pallet station of the manual assembly station in the first and the second position. The occupational safety of the worker can be additionally improved in this case. A separate protective shield of the above-described type can be provided in each manual assembly station of manual double assembly stations.

In one additional development of this embodiment, the protective shield seals the pallet station of the manual assembly station in a light-tight fashion in its first position. This makes it possible to carry out optical measurements on a pallet or its module under defined light conditions, e.g., for quality control purposes. The manual assembly station may be equipped with suitable cameras and/or suitable artificial light sources for this purpose.

In another preferred embodiment, the assembly cell features at least one automated assembly station with a changeover device for automatically changing over between several assembly tools. Different types of assembly work sequences can be carried out in such an assembly station; it is possible, in particular, to select the assembly tool in accordance with the arriving pallet. The automated assembly station can be used several times in the assembly sequence for a module or used for various types of pallets with different modules. The overall capacity utilization of the automated assembly station can be significantly increased in this fashion.

Another preferred embodiment is characterized in that the assembly cell features at least one automated assembly station, and in that the automated assembly station is provided with its own first traversing device that is able to displace a pallet relative to a tool of the automated assembly station that is stationarily arranged in the assembly station such that different locations on the pallet become accessible to the tool. If a tool needs to be used several times at different locations of a pallet during an assembly work sequence, it is not necessary to displace the usually heavy tool together with its carrier. This embodiment is particularly suitable for handling pallets, on which several identical modules are arranged.

In another advantageous embodiment, the assembly cell features at least one automated assembly station, wherein the automated assembly station comprises at least two pallet stations and an assembly station for carrying out assembly work on a pallet, wherein the assembly station represents, in particular, another pallet station that is accessible to the transport device, and wherein the automated assembly station is provided with its own second traversing device that makes it possible to displace an individual pallet between the assembly station and each pallet position of the automated assembly device and vice versa. The second traversing device is typically realized in the form of a two-part device, in which the two parts are respectively designed for the displacement to and from one of the pallet stations to the assembly station. The automated assembly station is largely decoupled from the transport device in this embodiment. The pallet changing time of the automated assembly station is significantly reduced in that a processed pallet is immediately removed from the assembly station and replaced with a locally supplied pallet yet to be processed. A significant increase in the capacity utilization of the automated assembly station is therefore achieved.

An equally advantageous embodiment is characterized in that the assembly cell features at least one automated assembly station, in that the automated assembly station comprises a first and a second pallet station, both of which are arranged on a common slide that can be displaced between two positions by means of a third traversing device, in that the first pallet station is accessible to the transport device and a pallet in the second pallet station is accessible for assembly work by the automated assembly station in the first position of the slide, and in that the second pallet station is accessible to the transport device and a pallet in the first pallet station is accessible for assembly work by the automated assembly station in the second position of the slide. The automated assembly station is also largely decoupled from the transport device in this embodiment. The pallet changing time of the automated assembly station is significantly reduced in that a processed pallet situated in the first pallet station is immediately replaced with a locally stored pallet yet to be processed that is situated in the second pallet station or vice versa. This makes it possible to significantly increase the capacity utilization of the automated assembly station. In comparison with the preceding embodiment, this embodiment provides the advantage of a simplified design with fewer axes of motion.

In one preferred additional development of the four aforementioned embodiments of an inventive assembly cell, the automated assembly station is realized in the form of a joining device. Joining and pressing processes need to be carried out in a particularly frequent fashion in assembly sequences such that the overall efficiency of the assembly cell can be improved with this measure.

In another advantageous embodiment of an inventive assembly cell, the assembly cell features a central work piece storage with at least one pallet station and one work piece distributor, wherein the work piece distributor is realized in such a way that it can transport work pieces from the central work piece storage to a pallet situated in the at least one pallet station of the work piece storage. In this embodiment, work pieces such as, in particular, larger or heavier work pieces to be attached to a module on a pallet in a manual assembly station, can be automatically delivered by the central work piece storage and initially intermediately stored on this pallet. The pallet is then transported to the manual assembly station and the immediately stored work pieces are then attached to the module by a worker at this location. It is preferred to store work pieces in the central work piece storage that are installed at different manual assembly stations. The central work piece storage eliminates the need for a local work piece storage in the manual assembly stations (for example, with local stacking boxes) or at least makes it possible to limit the local work piece storage to small parts.

In one advantageous embodiment, the transport device features a turning device for rotating a pallet about a vertical axis. This makes it possible to orient a pallet in a desired rotational position before the transfer to a pallet station or after it is received from a pallet station, particularly an assembly station. This is advantageous, for example, if several assembly cells are interconnected into an assembly system and the respective principal conveying directions in the assembly cells do not extend parallel to one another.

In one particularly preferred embodiment of the inventive assembly cell, the transport device can be displaced forward and backward in an X-direction on a horizontal guide, wherein the pallet stations are arranged on one side of the guide or to both sides of the guide. In this case, the pallet stations are conveniently loaded transverse to the principal conveying direction (X-direction). In addition, the assembly cell can be easily expanded by attaching additional pallet stations, particularly assembly cells, together with additional sections of the guide in the X-direction.

In one particularly preferred additional development of this embodiment, the transport device can be displaced along the guide with a linear motor. A linear motor allows a particularly fast and precise displacement of the triaxial module in the principal conveying direction (X-direction). The two remaining displacement directions (Y, Z) that are directed perpendicular to the X-direction and perpendicular to one another could also be realized with linear motors.

One particularly preferred additional development of the above-described embodiment is characterized in that several identical base platforms are provided that are successively arranged in the X-direction and fixed on one another in a reversible fashion, and in that the base platforms feature standardized receptacles, wherein assembly stations and/or buffer areas and/or sections of the guide of the transport device and/or central work piece storages and/or other devices of the assembly cell are fixed in a reversible fashion in at least some of the receptacles with corresponding leg elements, particularly screwed thereto. The base platforms make it possible to realize a modular design of the assembly cell that can be expanded in a particularly simple fashion. The devices arranged on a base platform are preferably realized in the form of stand-alone modules with their own control; data lines, power lines and, if applicable, other supply lines e.g., for compressed air, can be attached by means of plug-type connectors. In this embodiment, the assembly cell can be easily retrofitted if the modules to be assembled are changed, i.e., the assembly cell can be “recycled” in a cost-efficient fashion if the production changes. Investment costs can be lowered due to this measure.

The scope of the present invention also includes an assembly system that comprises at least two assembly cells according to one of the preceding claims and is characterized in that the assembly cells respectively feature pallet stations that are realized in the form of buffer areas, and in that at least some of the buffer areas of each assembly cell are assigned to two assembly cells simultaneously and therefore accessible to the transport devices of these two assembly cells (=transfer positions). Such an assembly system provides the option of easily interconnecting several assembly cells. Such an assembly system can be very well adapted to the local circumstances as far as space is concerned, and provides adequate options for expansion. It is also possible, in particular, to realize principal conveying directions of the concerned assembly cells that are adjoining in a T-shaped fashion.

One preferred embodiment of this assembly system comprises at least two assembly cells, wherein the guides of two adjacent assembly cells extend parallel to one another, and wherein buffer areas assigned to these two assembly cells simultaneously are provided between these guides. This results in a particularly compact design.

An interconnection of assembly cells in accordance with the invention can also be realized in that two (or more) assembly cells are arranged adjacent to one another and at least one transfer device is provided for transferring the modules or pallets from one assembly cell to the other assembly cell.

The scope of the present invention furthermore includes a method for operating an inventive assembly cell that is characterized in that alternative assembly work sequences can be carried out in at least one assembly station, and in that one of the alternative assembly work sequences is chosen and carried out depending on the pallet situated in the assembly station. This makes it possible to achieve a superior capacity utilization of this assembly station. In the state of the art, an assembly station is used for exactly one assembly work sequence in the assembly sequence of exactly one type of pallet or its module, respectively. An idle time (i.e., standstill time) always occurs in this assembly station when the duration of the assembly work sequence (i.e., the assembly time) in this assembly station is shorter than the assembly time in any of the remaining assembly stations used in the assembly sequence for this pallet. According to the inventive method, the idle time is used for alternative assembly work sequences. In addition, the work in the manual assembly stations is diversified for the worker due to alternative assembly work sequences such that the work becomes more pleasant and therefore less fatiguing.

In one advantageous variation of the inventive method, the same pallet is transported to the same assembly station several times in the work sequence for a module on a pallet and the module on the pallet then respectively undergoes the different assembly work sequences in this assembly station. This is one option for increasing the capacity utilization of this assembly station. The sum of the assembly times in this assembly station preferably does not exceed the longest assembly time in one of the remaining assembly stations during the assembly sequence for this pallet.

In another variation of the inventive method, various types of pallets that respectively carry different modules are processed simultaneously in the assembly cell. In this case, alternative assembly work sequences are typically carried out on the various types of pallets in at least some of the assembly stations. This also makes it possible to increase the capacity utilization in these particular assembly stations.

One additional development of this variation of the method is characterized in that the assembly cell features N manual assembly stations, wherein N is greater than or equal to 2, in that at least M types of pallets that respectively carry different modules are processed in the assembly cell, in that M is greater than or equal to N, and in that for each manual assembly station at least one type of pallet is provided, in the work sequence of which this manual assembly station carries out the assembly before all other manual assembly stations. This ensures that work in all other manual assembly stations can continue if work in one manual assembly station is interrupted (for example, if the workers assigned to this station takes a break), namely without having to configure a buffer prior to the interruption. The pallets processed in all remaining manual assembly stations are transported to buffer areas, if necessary.

With respect to the above-described method according to the invention. and its variations, a manual double assembly station, if so provided, functionally represents a single (manual) assembly station in the sense of the invention.

Other advantages of the invention result from the description and the drawings. The above-described characteristics, as well as the characteristics yet to be described below, may be respectively utilized, according to the invention, individually or in arbitrary combinations. The illustrated and described embodiments should not be interpreted as a conclusive itemization, but rather as having an exemplary character for the description of the invention.

### DRAWINGS

The invention is illustrated in the drawings and described in greater detail below with reference to embodiments thereof. In these drawings:

FIG. 1 shows a schematic top view of an inventive assembly cell;

FIG. 2 shows a schematic top view of an inventive assembly system that comprises two assembly cells;

FIG. 3a shows a schematic side view of a manual assembly station of an inventive assembly cell with a safety roller shutter that is situated in a first position suitable for changing the pallet;

FIG. 3b shows a schematic side view of the manual assembly station according to FIG. 3a with the safety roller shutter in a second position suitable for the assembly by a worker;

FIG. 4 shows a schematic oblique view of a manual double assembly station of an inventive assembly cell with a triaxial module;

FIG. 5 shows a schematic side view of a triaxial module of an inventive assembly cell, and

FIG. 6 shows a schematic oblique view of a joining device for an inventive assembly cell that features a tool changeover device and a common displaceable slide for two pallet stations.

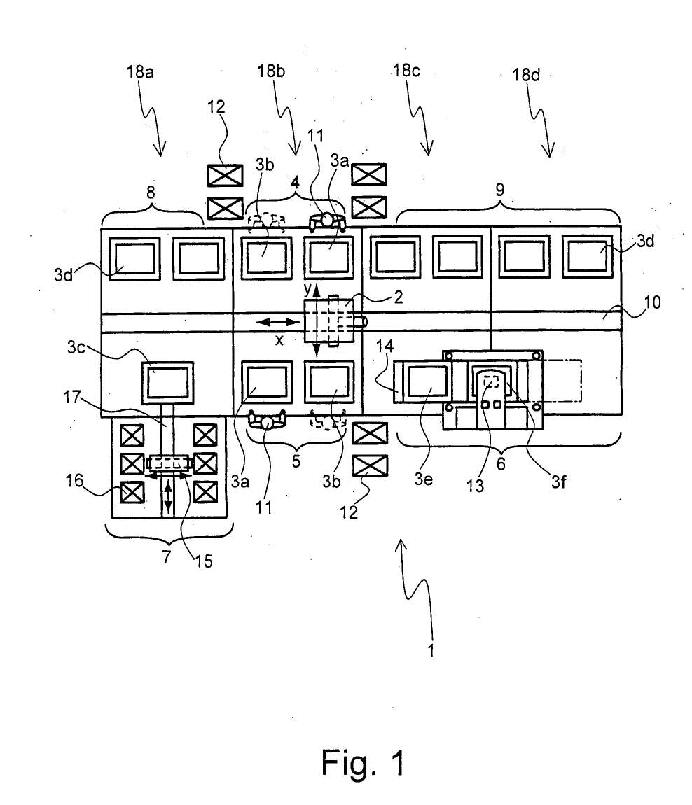

FIG. 1 shows a schematic top view of an inventive assembly cell 1. The assembly cell 1 comprises a triaxial module 2 for transporting pallets between pallet stations 3a, 3b, 3c, 3d, 3e, 3f of different devices of the assembly cell 1. The pallet stations 3a-3f are the locations in the assembly cell 1 that are accessible to the triaxial module 2 and at which pallets can be positioned. According to the invention, the triaxial module 2 is able to directly and therefore also quickly transport pallets between the pallet stations 3a-3f. The devices of the assembly cell 1 consist of two manual double assembly stations 4, 5, a joining device 6, a central work piece storage 7 and buffer areas 8, 9.

The triaxial module 2 can be displaced in the X-direction on a horizontal, straight guide 10 by means of a not-shown linear motor. It can also be displaced vertically up and down in the Z-direction, i.e., perpendicular to the plane of projection. The triaxial module 2 is furthermore realized in a telescoping fashion in the horizontal Y-direction that extends perpendicular to the X-direction in order to access pallets that are arranged in the pallet stations 3a-3f to both sides of the guide 10.

The scope of the invention also includes the utilization of a transport device with more than three axes of motion for example, a 6-axis module. However, the transport device needs to have at least three axes of motion in order to be suitable for use as a triaxial module 2 in accordance with the invention. A triaxial module may also be provided with a short-stroke device in order to realize a movement in the Z-direction. The short-stroke device may operate, in particular, with a fixed stroke. Suitable short-stroke devices are, for example, hooks that are positioned underneath and able to lift a pallet and vice versa. The typical stroke of a short-stroke device amounts to 5 to 10 mm; this suffices for preparing a pallet for a horizontal displacement.

The manual double assembly stations 4, 5 respectively comprise two pallet stations 3a, 3b that are realized in the form of manual assembly stations. Only one worker is active in each manual double assembly station 4, 5, namely alternately in one or the other manual assembly station or one or the other pallet station 3a, 3b; this is indicated with a worker that is illustrated with broken lines in the alternative work position. While the worker 11 carries out assembly work on a module on a pallet, for example, in the pallet station 3a, the triaxial module 2 transports away a processed pallet (for example, to one of the buffer areas 8, 9) and makes available a pallet yet to be processed in the other pallet station 3b.

The work pieces to be attached to the modules on the pallets by the worker 11 are either made available in local stacking boxes 12 or intermediately stored on the pallet to be processed and originate from the central work piece storage 7.

The assembly cell 1 furthermore comprises a joining device 6 that is able to carry out joining work on the modules on the pallets with a tool 13, e.g., a press adapter. The joining device 6 comprises a slide 14 that can be displaced between two positions parallel to the X-direction by means of a not-shown third traversing device. The first position is illustrated in FIG. 1 and the second position to the right thereof is indicated with a dot-dash line. Two pallet stations 3e and 3f are arranged on the slide 14. In the first position of the slide 14 shown, the first pallet station 3e is accessible to the triaxial module 2, wherein the tool 13 can carry out joining work on the pallet situated in the second pallet station 3f. After the joining work is completed, the slide 14 is displaced into the second position and the processed pallet of the second pallet station 3f is replaced with a pallet yet to be processed by means of the triaxial module 2. Joining work can be simultaneously carried out on a pallet in the first pallet station 3e.

The assembly cell 1 furthermore features a central work piece storage 7 that comprises a pallet station 3c, a work piece distributor 15 as well as bins 16 for work pieces. Work piece holders or the like may be provided instead of bins for sensitive work pieces. The work piece distributor 15 can be displaced along a guide 17, as well as displaced or telescoped vertically and horizontally perpendicular thereto. If a pallet is situated in the pallet station 3c, the work piece distributor transports work pieces to this pallet. The work pieces are selected in accordance with the module on the pallet and deposited on the pallet (intermediate storage). The actual assembly takes place in one of the assembly stations.

In addition, the assembly cell 1 also features buffer areas 8, 9. No assembly work is carried out on the pallets situated in the pallet stations 3d that are realized in the form of buffer areas 8, 9. The pallets are merely stored in these buffer areas until the device or the pallet station to which the respective pallet should be transported next becomes available.

The assembly cell 1 is composed of four base platforms 18a , 18b , 18c , 18d that are arranged in a row in the X-direction and fixed on one another in a reversible fashion. For example, the two manual double assembly stations 4, 5 as well as a section of the guide 10 are arranged on the base platform 18b. The joining device 6 is so large that it is fixed on two base platforms 18c , 18d. The base platforms 18a-18d feature standardized receptacles for fixing devices arranged thereon in a reversible fashion. The assembly cell can also be easily expanded due to this modular design, e.g., by adding further base platforms in the X-direction. The assembly cell 1 can furthermore be easily modified. For example, if a manual double assembly station 4 should be replaced with an automated assembly station, the base platform 18b may remain in the assembly cell 1 and it is merely required to exchange the double assembly station 4 in the standardized receptacle of the base platform 18b.

The base platforms 18a-18d are provided with leveling elements in the form of (not-shown) adjustable legs. This makes it possible to also easily align the assembly cell 1 on uneven ground.

An exemplary work sequence for a pallet in the assembly cell 1 could read as follows: reception of a pallet from the buffer areas 8 (that simultaneously serve as feed-in areas for pallets to be processed that carry partially assembled modules), transport to the manual double assembly station 4, attachment of a few work pieces to the module in this double assembly station, transport to the joining device 6 and pressing on already attached work pieces, transport to the buffer areas 9, transport to the central work piece storage 7, in which a few work pieces are intermediately stored on the pallet, transport to the manual assembly station 5, in which the intermediately stored work pieces and other small parts are attached to the module, transport to the buffer areas 9, transport to the joining device 6 and pressing on a few already attached work pieces, transport to the buffer areas 8, transport to the central work piece storage 7, in which additional work pieces are intermediately stored on the pallet, transport to the manual assembly station 4, in which the intermediately stored work pieces are attached to the module, transport to the buffer areas 9, transport to the joining device 6, in which a few already attached work pieces are pressed on, transport to the buffer areas 9 (that simultaneously serve as feed-out areas for processed pallets).

In the inventive assembly cell 1, the capacity utilization of assembly stations of the assembly cell 1 can be increased in that the same assembly station is used for different alternative assembly work sequences. However, the capacity utilization of assembly stations of an inventive assembly cell 1 can also be increased, according to the invention, with the parallel utilization of several assembly stations for carrying out particularly time-consuming assembly work sequences.

In other words, if a particularly time-consuming assembly work sequence is about to be carried out on a module on a pallet, the pallet can be transported to one of several assembly stations that are all designed for carrying out this assembly work sequence. If so required, the cycle of the assembly of a module in the assembly cell can be subsequently increased by expanding the assembly cell by several assembly stations designed for carrying out the time-consuming assembly work sequence.

The assembly cell 1 is realized in the form of a spatially closed system that only allows access at defined service access points. Such service access points may consist of doors and be realized on the right and/or left end of the guide 10. If the space along the guide 10 is not entirely used or occupied by devices such as assembly stations in the assembly cell 1, protective walls are provided on unused sections. This prevents persons situated in the vicinity of the assembly cell 1 from accidentally reaching into the region of the rapidly moving triaxial module 2 and possibly suffering injuries.

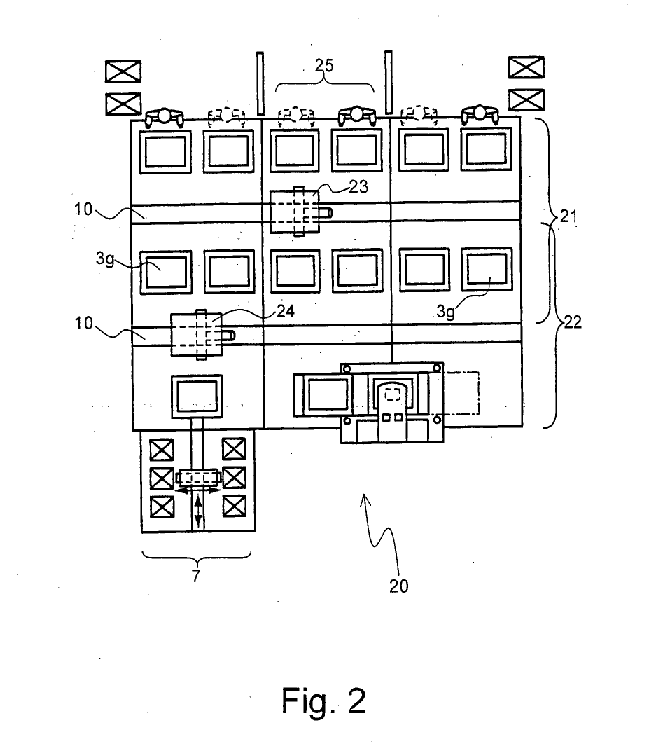

FIG. 2 shows a schematic top view of an inventive assembly system 20 that comprises two assembly cells 21, 22. The two assembly cells 21, 22 overlap in a region between the two guides 10 of the two triaxial modules 23, 24. Pallet stations 3g realized in the form of buffer areas are situated in this overlapping region. Pallets in these pallet stations 3g can be handled by the triaxial module 23 of the assembly cell 21 as well as by the triaxial module 24 of the assembly cell 22. The pallet stations 3g therefore represent transfer positions for pallets between the two assembly cells 21, 22.

According to the invention, the assembly cell 21, 22 can also be changed, particularly also several times, in the work sequence for a module on a pallet. For example, a manual double assembly station 25 of the upper assembly cell 21 shown in FIG. 2 does not feature a local work piece storage. Pallets arriving in the manual double assembly station 25 were previously transported to the central work piece storage 7 of the lower assembly cell 22 in order to collect all work pieces to be attached.

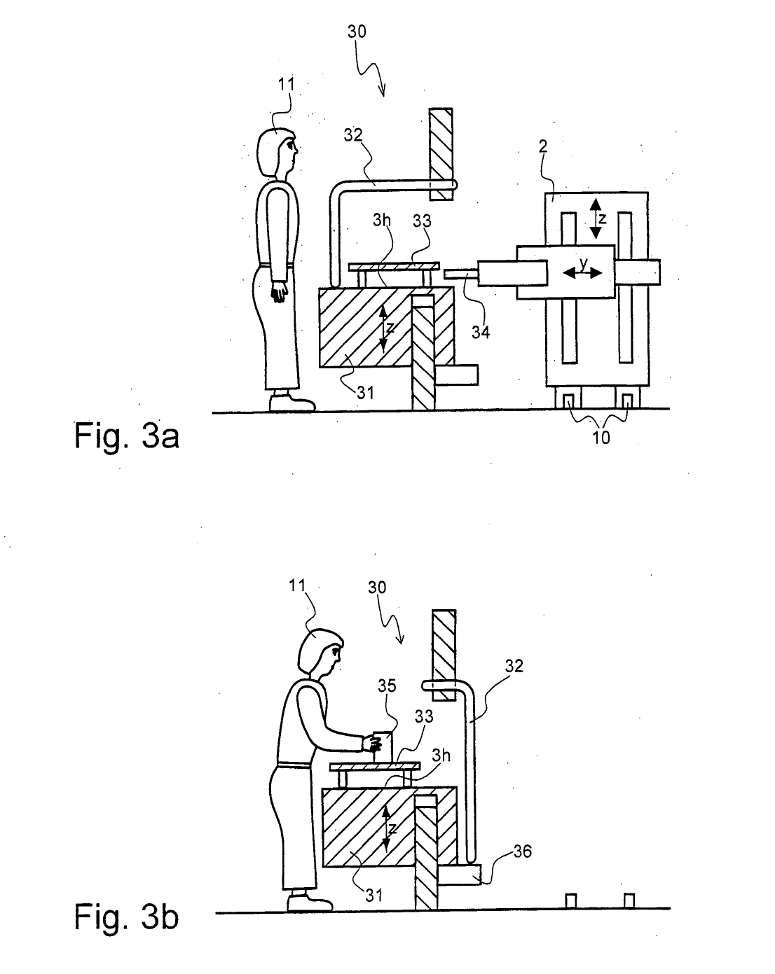

FIG. 3a shows a schematic side view of a manual assembly station 30 that forms part of an inventive assembly cell. The manual assembly station 30 comprises an assembly table 31 and a protective shield 32 that is realized in the form of a safety roller shutter. A pallet 33 ready for manual assembly work is already deposited on the upper side of the assembly table 31. In this context, the upper side of the assembly table 31 represents a pallet station 3h. The pallet 33 was just delivered by a triaxial module 2. A telescopic arm 34 of the triaxial module 2 had the function of engaging underneath the pallet 33 for the transport thereof and is currently retracted or pulled back toward the triaxial module 2 in FIG. 3a. The triaxial module 2 can be displaced on a guide 10 that extends perpendicular to the plane of projection (X-direction).

In FIG. 3a, the protective shield 32 is situated in a first position, in which access to the pallet station 3h and the pallet 33 is completely blocked for a worker 11. Consequently, the worker 11 is not jeopardized by the transport of the pallet 33 by means of the triaxial module 2, particularly the displacement of the telescopic arm 34. However, the triaxial module 2 has free access to the pallet station 3h.

FIG. 3b shows the manual assembly station 30 according to FIG. 3a in a second position of the protective shield 32. The protective shield 32 completely seals the prior access of the triaxial module 2 to the pallet station 3h or the pallet 33. However, the worker 11 has free access to the pallet station 3h or the pallet 33, respectively. Consequently, the worker 11 is able to attach a work piece 35 to the pallet 33 or a (not-shown) module on the pallet 33.

At least the assembly table 31 of the manual assembly station 30 is realized in a height-adjustable fashion, i.e., the upper edge of the assembly table 31 can be vertically displaced in the Z-direction. This is achieved with a motor 36; alternatively, it would also be conceivable to utilize manual traversing devices such as, for example, a spindle drive. Once a new worker 11 is active at the manual assembly station 30, the Z-position of the assembly table 31 is adapted to the body size of the new worker. The Z-position of the assembly table 31 is signaled to a control unit of the triaxial module, preferably in an automated and electronic fashion, such that the triaxial module can adjust the correct Z-position for the telescopic arm when it delivers and transports away a pallet 33.

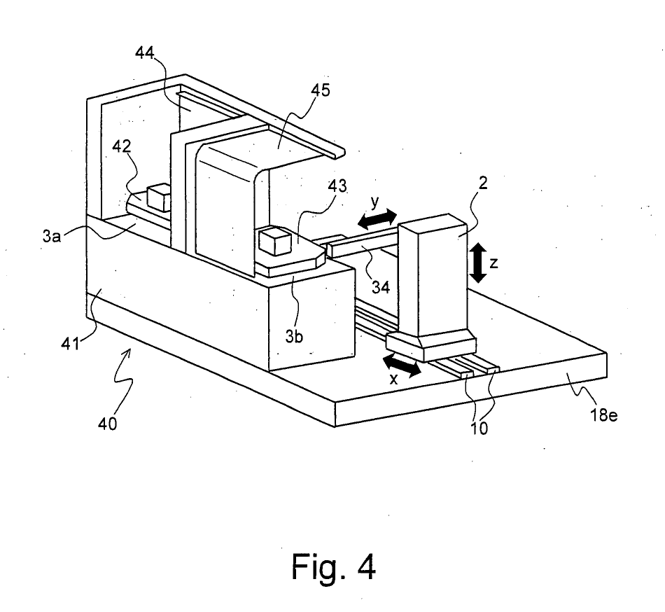

FIG. 4 shows an oblique view of a manual double assembly station 40 with a triaxial module 2 of an inventive assembly cell. The manual double assembly station 40 comprises two pallet stations 3a, 3b that are respectively realized in the form of manual assembly stations. One respective pallet 42, 43 is situated in each of the two pallet stations 3a, 3b.

In the left pallet station 3a, a (not-shown) worker can carry out assembly work, particularly the attachment of work pieces, on the pallet 42 that is accessible to the worker from the front. A safety roller shutter 44 seals this manual assembly station 40 or pallet station 3a rearward, namely toward the triaxial module 2 or its displacement region, respectively.

In the right pallet station 3b, no assembly work can be carried out on the pallet 43 by a worker. A safety roller shutter 45 seals this manual assembly station or its pallet station 3b forward, namely toward a (not-shown) worker. In FIG. 4, a wall on the right side of the right manual assembly station was omitted in order to provide a better overview. However, the pallet station 3b is accessible to the triaxial module 2 from the rear in the position of the safety roller shutter 45 shown such that the pallet 43 can be transported.

The triaxial module 2 can be moved in three directions in order to transport a pallet: it can be displaced back and forward in the X-direction along the guide 10, a telescopic arm 34 can be displaced in the Y-direction, i.e., horizontally and perpendicular to the X-direction, and the telescopic arm 34 or its suspension can be displaced vertically up and down in the Z-direction.

The manual double assembly station 40 and the triaxial module 2 along with its guide 10 are arranged on a base platform 18e.

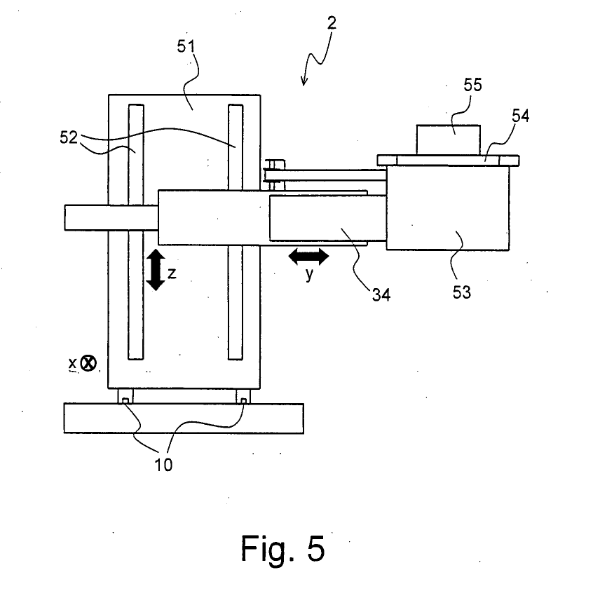

In FIG. 5, a triaxial module 2 suitable for use in the present invention is illustrated in detail in the form of a schematic side view.

The triaxial module 2 comprises a base body 51 that can be displaced in the X-direction (perpendicular to the plane of projection) on the guide 10 by means of a linear motor arranged in the base body 51. Vertical guides 52 are arranged on the base body 51, wherein a telescopic arm 34 or its suspension can be vertically displaced in the Z-direction on these vertical guides. The telescopic arm 34 can be horizontally displaced toward the left and the right in the Y-direction; FIG. 5 shows a position in which the telescopic arm is displaced toward the right. The Y-displacement from the left to the right and vice versa is also possible, in particular, when a pallet is situated on the triaxial module.

A pallet transport head 53 is arranged at the end of the telescopic arm 34, wherein this pallet transport head is designed in such a way that it can securely hold and transport a pallet 54. The pallet transport head 53 may feature gripping tools or clamps for this purpose. The pallet transport head 53 and the pallet 54 may be simply realized such that the pallet transport head 53 engages underneath the pallet and the pallet 54 flatly lies on the pallet transport head 53 such that it cannot slide or tilt when the pallet transport head 53 is raised. A partially assembled module 55 is situated on the pallet 54.

All degrees of freedom of the movement (X, Y, Z) of the triaxial module 2 can be controlled independently of one another. The control is typically NC-based or CNC-based

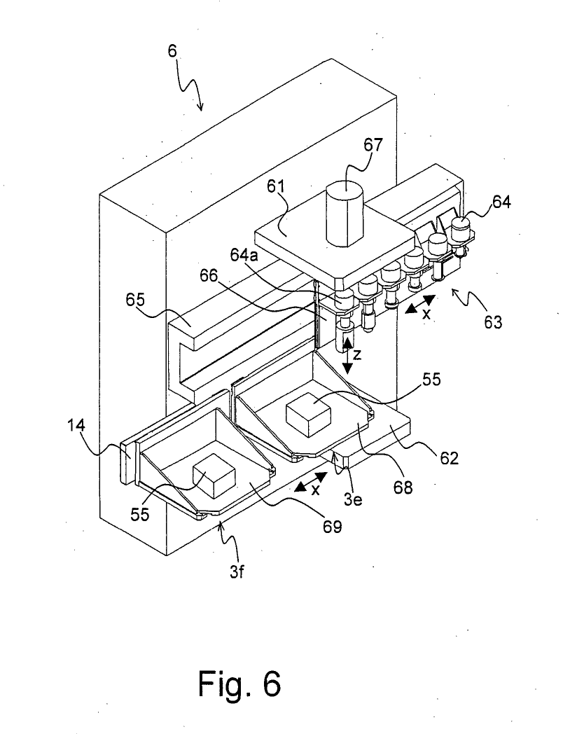

FIG. 6 shows a schematic oblique view of a joining device 6 suitable for use in an inventive assembly cell.

The joining device 6 features an upper press plate 61 and a fixed press table 62. The joining device 6 furthermore features a changeover device 63 that makes it possible to change over between different assembly tools 64, namely press adapters. For this purpose, a sextuple magazine 66 with 6 press adapters can be displaced in the X-direction in a horizontal guide 65 such that one of the press adapters is arranged in a suitably aligned position for the pressing process between the press plate 61 and the press table 62. In FIG. 6, the leftmost press adapter 64a is aligned for a pressing process. A spindle motor 67 makes it possible to lower the press adapter 64a on the press table 62 in the Z-direction and to subsequently raise the press adapter again.

A pallet with a work piece or module to be pressed is handled with a slide 14 in the joining device 6. The slide 14 features two pallet stations 3e, 3f, on which pallets 68, 69 with modules 55 are arranged. The slide 14 can be displaced in the X-direction by means of a not-shown third traversing device. In order to carry out the joining process, a pallet station is displaced between the press plate 61 and the press table 62 together with its pallet, e.g., the pallet station 3e with the pallet 68, such that the work piece of the module 55 to be joined is able to cooperate with the prepared press adapter 64a. While the joining process takes place in the pallet station 3e, a pallet change may be carried out in the other pallet station 3f by means of the triaxial module.

The slide 14 is subsequently displaced in such a way (toward the right in FIG. 6) that the other pallet station 3f or the module 55 on the pallet 69 is situated above the press table 62 for a pressing process and a pallet is exchanged by the triaxial module in the pallet station 3e. The assembly tool 64, i.e., the press adapter, can be changed over, if so required, while the slide 14 is displaced.

The described joining device 6 can also be used independently of the assembly cell according to the invention and, in particular, without a triaxial module. Consequently, a joining device 6 with a changeover device 63 for automatically changing over between several assembly tools 64 can be interpreted as an independent invention. Possible embodiments of this independent invention correspond to the characterizing portions of dependent Claims 9 to 11.

What is claimed is:

1. An assembly cell suitable for assembly of modules from work pieces on pallets, the assembly cell comprising:
a plurality of pallet stations for receiving pallets, at least some of the pallet stations being assembly stations for carrying out assembly work on pallet supported modules;
at least one triaxial transport device for transporting individual pallets from any pallet station within the assembly cell to any other unoccupied pallet station with the assembly cell; and
at least one manual double assembly station, each manual double assembly station including two manual assembly station enabling a worker to alternatively carry out assembly work.

2. The assembly cell according to claim 1, wherein the manual double assembly station is configured for enabling assembly work to be carried out at one of the manual assembly stations of the double assembly station, and an already processed pallet is replaced with a pallet yet to be processed in another manual assembly station of the manual double assembly station.

3. The assembly cell according to claim 1 wherein the two manual assembly stations of the manual double assembly station comprise adjacent pallet stations configured for enabling a worker to directly change over from one of the manual assembly stations of the manual double assembly station to another manual assembly station of the manual double assembly station.

4. The assembly cell according to claim 1 wherein the two manual assembly stations of the manual double assembly station comprise a common partition wall arranged between the two pallet stations of the manual assembly stations of the manual double assembly station.

5. The assembly cell according to claim 1 wherein at least some of the pallet stations are configured as buffer areas, at which no assembly work can be carried out on the modules.

6. The assembly cell according to claim 5, wherein several buffer areas are arranged vertically on top of one another.

7. The assembly cell according to claim 1 wherein at least one manual assembly station for carrying out assembly work by a worker is height-adjustable.

8. The assembly cell according to claim 1 wherein at least one manual assembly station includes a displaceable protective shield, the shield comprising a safety roller shutter displaceable between two positions, access to the pallet station of the manual assembly station being completely blocked for a worker in a first position of the protective shield while the transport device is able to access the pallet station of the manual assembly station in the first position, and in a second position the worker is able to access the pallet station of the manual assembly station in order to carry out assembly work while access to the pallet station of the manual assembly station is completely blocked for the transport device in the second position.

9. The assembly cell according to claim 8 wherein the protective shield seals the pallet station of the manual assembly station in a light-tight fashion in the first position.

10. The assembly cell according to claim 1 further comprising at least one automated assembly station with a changeover device for automatically changing between several assembly tools.

11. The assembly cell according to claim 1 further comprising at least one automated assembly station, the automated assembly station including a first traversing device for displacing a pallet relative to a tool of the automated assembly station that is stationarily arranged in the assembly cell such that different locations on the pallet become accessible to the tool.

12. The assembly cell according to claim 1 further comprising at least one automated assembly station, the automated assembly station comprising at least two pallet stations and an assembly station for carrying out assembly work on a pallet and wherein the assembly station includes another pallet station accessible to the transport device, and the automated assembly station includes a second traversing device enabling displacement of an individual pallet between the assembly station and each pallet station of the automated assembly device and vice versa.

13. The assembly cell according to claim 1 further comprising at least one automated assembly station, the automated assembly station comprising a first and a second pallet station, both being arranged on a common slide, wherein the slide is displaceable between two positions by means of a third traversing device, the first pallet station is accessible to the transport device and a pallet in the second pallet station is accessible for assembly work by the automated assembly station in the first position of the slide, and the second pallet station is accessible to the transport device and a pallet in the first pallet station is accessible for assembly work by the automated assembly station in the second position of the slide.

14. The assembly cell according to claim 10 wherein the automated assembly station comprises a joining device.

15. The assembly cell according to claim 1 further comprising a central work piece storage with at least one pallet station and a work piece distributor, and wherein the work piece distributor is configured for transporting work pieces from the central work piece storage to a pallet situated in the at least one pallet station of the work piece storage.

16. The assembly cell according to claim 1 wherein the transport device comprises a turning device for rotating a pallet about a vertical axis.

17. The assembly cell according to claim 1 wherein the transport device is displaceable forward and backward in an X-direction on a horizontal guide, and the pallet stations are arranged on one side of the guide or to both sides of the guide.

18. The assembly cell according to claim 17, wherein the transport device is displaceable along the guide with a linear motor.

19. The assembly cell according to claim 16 further comprises several identical base platforms successively arranged in the X-direction and fixed on one another in a reversible fashion, and the base platforms include standardized receptacles, and wherein assembly stations and/or buffer areas and/or sections of the guide of the transport device and/or central work piece storages and/or other devices of the assembly cell are fixed in an reversible fashion in at least some of the receptacles with corresponding leg elements, attached thereto.

20. An assembly system comprising at least two assembly cells according to claim 1 and wherein the assembly cells respectively have pallet stations including buffer areas, and at least some of the buffer areas of each assembly cell are assigned to two assembly cells simultaneously and accessible to the transport devices of the two assembly cells.

21. The assembly system according to claim 20 comprising at least two assembly cells according to claim 15 and wherein the guides of two adjacent assembly cells extend parallel to one another, and buffer areas assigned to the adjacent assembly cells are disposed between these guides.

22. A method for operating an assembly cell in accordance with claim 1 comprising carrying an alternative assembly work sequences in at least one assembly station, and one of the alternative assembly work sequences is chosen and carried out depending on the pallet situated in the assembly station.

23. The method according to claim 22, further comprising transporting the same pallet to the same assembly station several times in the work sequence for a module on a pallet in order that the module on the pallet undergoes the different assembly work sequences in the assembly station.

24. The method according to claim 22 further comprising simultaneous processing various types of pallets that respectively carry different modules in the assembly cell.

25. The method for operating an assembly cell according to claim 24 wherein the assembly cell includes N manual assembly stations, wherein N is greater than or equal to 2, and at least M types of pallets that respectively carry different modules are processed in the assembly cell wherein M is greater than or equal to N, and for each manual assembly station at least one type of pallet is provided, in the work sequence of which the manual assembly station carries out the assembly before all other manual assembly stations.
